(19) United States
(12) Patent Application Publication
(10) Pub. No.: US 2026/0008245 A1
(43) Pub. Date: Jan. 8, 2026

(54) Method, tire manufacturing line and computer program product for manufacturing a continuous strip

(71) Applicant: VMI Holland B.V., EPE (NL)

(72) Inventors: Willem Marinus VAN BEEK, EPE (NL); Timen Anton VAN WERVEN, EPE (NL); Robin NUSSELDER, EPE (NL)

(21) Appl. No.: 19/129,196

(22) PCT Filed: Oct. 17, 2023
(86) PCT No.: PCT/NL2023/050541

§ 371 Date: May 12, 2025

(30) Foreign Application Priority Data
Nov. 11, 2022 (NL) 2033508

(51) Int. Cl. B29D 30/00; B29D 30/48

(52) U.S. Cl. CPC B29D 30/0016; B29D 30/48; B29D 2030/0038; B29D 2030/481

(57) ABSTRACT

A method for manufacturing a continuous strip in a tire manufacturing line includes the steps of:

a) operating the tire manufacturing line in a tire manufacturing mode;

b) conveying the continuous strip in a conveyance direction along a conveyance path in the tire manufacturing mode;

c) switching over the tire manufacturing line from the tire manufacturing mode to an interruption mode; and

d) controlling conveying the continuous strip back-and-forth in the conveyance direction and a retraction direction opposite to the conveyance direction along the conveyance path.

### BACKGROUND

The invention relates to a method, a tire manufacturing line and a computer program product for manufacturing a continuous strip, in particular a continuous strip for use in building a green or unvulcanized tire.

In a known tire manufacturing line, an apex is manufactured by extruding a continuous strip of elastomeric or rubber material. When the continuous strip leaves the extruder, it is allowed to shrink on a shrink conveyor and is subsequently guided onto cooling drum via several guide rollers. The continuous strip is ultimately cut to length in a cutting station to form the individual apexes, which are then transported further downstream to be assembled with a bead into a bead-apex. Typically, a festooner is provided as a buffer between the continuous supply of the extruder and the discontinuous cutting at the cutting station.

### SUMMARY OF THE INVENTION

A disadvantage of the known tire manufacturing line is that the material of the continuous strip that has just left the extruder is still relatively warm and soft when it is passed over the shrink conveyor and around the cooling drum, and therefore deforms easily. When the tire manufacturing line is running normally, deformation is usually not an issue because the continuous strip is continuously being moved and kept under sufficient tension to prevent slacking. However, when the tire manufacturing process is interrupted for some reason, the tire manufacturing line may come to a stop, leaving the relative warm and soft continuous strip stationary on the shrink conveyor, the guide rollers and the cooling drum. After a while, parts of the continuous strip may settle in and conform to the shape of the rollers on which they are supported. The longer the interruption lasts, the more the continuous strip cools down and any deformations as a result of settling will be more difficult to smoothen. This may cause quality issues further downstream.

Moreover, the continuous strip may stick to the rollers, making it difficult to restart the tire manufacturing line and potentially causing malfunctions because the continuous strip may be pulled in between the rollers instead of conveying said continuous strip further over the rollers.

It is an object of the present invention to provide a method, a tire manufacturing line and a computer program product for manufacturing a continuous strip, wherein lasting deformations and/or sticking of the continuous strip during downtime of the tire manufacturing line can be reduced or prevented.

According to a first aspect, the invention provides a method for manufacturing a continuous strip in a tire manufacturing line, wherein the tire manufacturing line comprises at least one conveying unit for conveying the continuous strip along a conveyance path through the tire manufacturing line, wherein the method comprises the steps of:
a) operating the tire manufacturing line in a tire manufacturing mode;
b) controlling the at least one conveying unit to convey the continuous strip in a conveyance direction along the conveyance path in the tire manufacturing mode;
c) switching over at least a part of the tire manufacturing line, including the at least one conveying unit, from the tire manufacturing mode to an interruption mode; and
d) controlling the at least one conveying unit in the interruption mode to repeatedly move the continuous strip back-and-forth in the conveyance direction and a retraction direction opposite to the conveyance direction along the conveyance path.

The controlled back-and-forth movement of the continuous strip in the interruption mode can effectively ensure that, during downtime or any kind of stop of the tire manufacturing line, the continuous strip is not held stationary in a single or fixed position for too long when the continuous strip is still warm and soft. In particular, the continuous strip is repeatedly moved back-and-forth such that different parts of the continuous strip are supported on different parts or areas of the at least one conveying unit over time. The back-and-forth movement can prevent that the continuous strip settles in a stationary position on the conveying units and/or locally conforms to the shape of the parts of the at least one conveying unit on which it is supported. Moreover, the back-and-forth movement can smoothen out and/or reduce any deformations, making it less likely that such deformations cause quality issues further downstream.

In a preferred embodiment the at least one conveying unit, in step c), is controlled to stop moving the continuous strip along the conveyance path. By stopping the conveyance of the continuous strip at the end of the tire manufacturing mode, the interruption mode can be initiated in a controlled manner, independently of the conveyance of the continuous strip in the tire manufacturing mode.

More preferably, step d) is delayed from step c) with a time delay. Most preferably, the time delay is at least ten seconds, preferably at least thirty seconds and most preferably at least one minute. In some cases, the tire manufacturing mode may be interrupted only briefly. The time delay may prevent a start of the interruption mode when the downtime of the tire manufacturing mode is less than the time delay.

In another embodiment the continuous strip, after each repetition of the back-and-forth movement in step d) returns to the same or substantially the same position along the conveyance path. Hence, the net movement of the continuous strip in the conveyance direction can be kept close to zero or at zero.

Alternatively, the continuous strip, after each repetition of the back-and-forth movement in step d) returns to a different position along the conveyance path. This can ensure that different sections of the continuous strip are supported on the at least one conveying unit over time.

In another embodiment the continuous strip is moved back-and-forth in step d) over a first distance in the conveyance direction and a second distance in the retraction direction.

Preferably, the second distance is equal to the first distance for each repetition of the back-and-forth movement of the continuous strip in step d). This results in the aforementioned net movement of zero or close to zero after each repetition.

In a further embodiment the first distance remains constant for all repetitions of the back-and-forth movement of the continuous strip in step d). Hence, the back-and-forth movement can be a constant and/or periodic motion, in particular having a constant amplitude for each repetition.

Alternatively, the first distance is variable between repetitions of the back-and-forth movement of the continuous strip in step d). Preferably, the first distance is incrementally varied between repetitions of the back-and-forth movement of the continuous strip in step d). The first distance may be varied depending on the varying characteristics of the continuous strip over time, for example when the continuous strip cools down and hardens over time.

In a further embodiment the first distance and/or the second distance is at least three centimeters, preferably at least five centimeters and most preferably at least eight centimeters. Such a minimum distance may already be sufficient to reduce and/or prevent local deformations in the continuous strip.

In another embodiment the back-and-forth movement of the continuous strip in step d) is a periodic motion. Hence, the back-and-forth movement has a constant interval that ensures that the continuous strip is regularly and/or continuously kept in motion. Alternatively, the back-and-forth movement of the continuous strip in step d) is a non-periodic motion, i.e. having a variable interval. This may be useful when the continuous strip requires less motion over time as it cools down and/or hardens out.

In another embodiment the continuous strip, in the tire manufacturing mode, is moved in the conveyance direction at a production speed, wherein the continuous strip, in the interruption mode, is moved back-and-forth in step d) at an interruption speed that is less than eighty percent of the production speed, and preferably less than sixty percent. At such lower interruption speed, an operator can enter the tire manufacturing line safely despite the continuous strip moving back-and-forth.

In another embodiment the back-and-forth movement of the continuous strip in step d) is controlled automatically and/or pre-programmed. Hence, the back-and-forth movement does not require any human intervention or supervision. Moreover, the interruption mode can be initiated automatically in response to the tire manufacturing line being down, without any human intervention or human trigger.

In another embodiment the tire manufacturing line is switched over from the tire manufacturing mode to the interruption mode in response to an interruption signal. Preferably, the interruption signal is triggered by one of an automatically detected error in the tire manufacturing line or a user input at a human machine interface. Hence, when tire manufacturing line is shut down as a result of an error or a user input, the interruption mode can be started automatically without any human intervention or human trigger.

In another embodiment the at least one conveying unit comprises a first conveying unit and a second conveying unit located downstream of the first conveying unit along the conveyance path. The two conveying units can be controlled together and/or may cooperate to move the continuous strip back-and-forth in the interruption mode. In particular a length of the continuous strip extending along the conveyance path between the first conveying unit and the second conveying unit may be moved back-and-forth in a controlled manner by controlling both conveying units in the interruption mode.

Preferably, the first conveying unit and the second conveying unit are synchronously or substantially synchronously controlled to move the continuous strip back-and-forth in step d). Hence, when one of the conveying units is pushing the length of continuous strip between the conveying units, the other conveying unit can pull on said length, and vice versa.

Alternatively, the first conveying unit and the second conveying unit are alternately controlled to move the continuous strip in the retraction direction and the conveyance direction, respectively, in step d). Hence, when one of the conveying units is pulling, the other can rotate freely and/or follow the continuous strip passively.

In another embodiment the tire manufacturing line further comprises a tensioning device for tensioning the continuous strip between the first conveying unit and the second conveying unit, wherein the method further comprises the step of:
e) controlling the first conveying unit and the second conveying unit prior to or during step d) to generate excess length in the continuous strip at the tensioning device.

In other words, the tire manufacturing line further comprises a tensioning device that is movable between a low tension state and a high tension state for variably tensioning the continuous strip, wherein the method further comprises the step of:
e) controlling the tensioning device to move from the high tension state towards and/or into the low tension state.

When stationary, the continuous strip may start to stretch uncontrollably when kept under tension, in particular when the continuous strip is a cordless strip. By generating excess length in the continuous strip or by controlling the tensioning device to move towards the low tension state, tension generated by the tensioning device in the continuous strip can be reduced to reduce or prevent excessive stretching of the continuous strip at said tensioning device.

In another embodiment the at least one conveying unit comprises conveyor rollers. The cylindrical shape of the conveyor rollers may cause deformations in the continuous strip. Moreover, the conveyor rollers are typically spaced apart, thus allowing the continuous strip to sag in between the conveyor rollers. The method according to the present invention can reduce or prevent such deformations and/or sagging. In another embodiment the tire manufacturing line comprises an extruder for extruding the continuous strip, wherein the at least one conveying unit comprises a shrink conveyor for receiving the continuous strip from said extruder. Such a shrink conveyor typically includes conveyor rollers. The method according to the present invention may therefore have the same technical advantages as in the previously discussed embodiment.

In another embodiment the at least one conveying unit comprises a cooling drum. Such a cooling drum typically comes with a plurality of guide rollers that guide the continuous strip in a plurality of windings around the cooling drum. The method according to the present invention may therefore have the same technical advantages as in the previously discussed embodiments.

In another embodiment the at least one conveying unit comprises a festooner. Such a festooner typically includes conveyor rollers. The method according to the present invention may therefore have the same technical advantages as in the previously discussed embodiments.

In another embodiment the tire manufacturing line comprises at least one downstream station downstream of the at least one conveying unit, wherein the at least one downstream station, in particular a festooner, is controlled to hold the continuous strip stationary in the conveying direction along the conveyance path in the interruption mode. At the downstream stations, the continuous strip may have cooled down to such an extent that it no longer deforms easily when held stationary. Hence, the continuous strip can be held stationary at the at least one downstream station without experiencing the negative effects thereof.

In another embodiment the continuous strip is cordless strip, in particular for manufacturing an apex. A cordless strip is more likely to deform when freshly extruded and held stationary. Hence, the advantageous effect of the method according to the present invention will be greater for such a cordless strip.

Alternatively, the continuous strip is a cord-reinforced strip, in particular for manufacturing a breaker or a body ply. Although a cord-reinforced strip is less likely to deform when stationary, the freshly extruded elastomeric material in which the cords are embedded may still deform and the position of the cords in the elastomeric material may shift when stationary for longer periods of time. Hence, the method according to the present invention may also have advantageous effects when applied to cord-reinforced strips.

According to a second aspect, the invention provides a tire manufacturing line for manufacturing a continuous strip, wherein the tire manufacturing line comprises at least one conveying unit for conveying the continuous strip along a conveyance path through the tire manufacturing line and a control unit that is operationally connected to the at least one conveying unit, wherein the control unit is configured for executing the steps of the method according to any one of the embodiments of the first aspect of the invention.

According to a third aspect, the invention provides a computer program product comprising a non-transitory computer-readable medium holding instructions that, when processor, executed by a cause a tire manufacturing line according to the second aspect of the invention to perform the steps of the method according to any one of the embodiments of the first aspect of the invention.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a side view of a tire manufacturing line according to the invention operating in a tire manufacturing mode;

FIG. 2 shows a side view of the tire manufacturing line of FIG. 1 during a switch over from the tire manufacturing mode to an interruption mode;

FIG. 3 shows a side view of the tire manufacturing line of FIG. 1 operating in the interruption mode;

FIG. 4 shows a graph with different drive profiles for controlling the tire manufacturing line of FIG. 3 in the interruption mode; and

FIG. 5 shows a flow chart with steps of a method for manufacturing a continuous strip in the tire manufacturing line of FIG. 1.

### DETAILED DESCRIPTION OF THE INVENTION

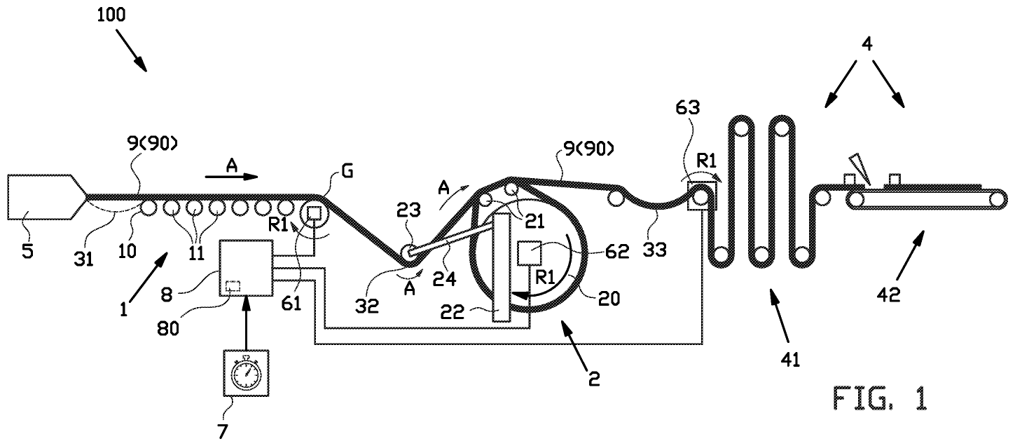

FIG. 1 shows a tire manufacturing line 100 according to an exemplary embodiment of the invention for manufacturing a continuous strip 9 from which tire components are cut to build and/or assemble a green or unvulcanized tire.

The tire manufacturing line 100 comprises an extruder 5 for extruding the continuous strip 9 and one or more conveying units 1, 2 for conveying the continuous strip 9 in a conveyance direction A along a conveyance path G towards one or more downstream stations 4. In this example, the one or more downstream stations 4 comprises a festooner 41 and a cutter 42. The cutter 42 is configured for cutting the continuous strip 9 to length. The cut lengths of the continuous strip 9 may subsequently be used in any tire assembly processes (not shown) downstream of the cutter 42. The festooner 41 is used as a buffer between the continuous output of the extruder 5 and the discontinuous or intermittent cutting operation at the cutter 42.

In this example, the continuous strip 9 is used to form filler strips or apexes. An apex is shaped into an annular configuration and combined with a bead at a bead-apex drum to form an bead-apex assembly in an manner known per se. The apex comprises a body of elastomeric or rubber material with a triangular or tapering cross section. Typically, the apex does not comprise any embedded reinforcement cords.

The invention may however be applied, mutatis mutandis, to other continuous strips for use in tire manufacturing, for example to gum strips or to cord-reinforced strips such as breaker plies, body plies, cap strips or run-flat reinforcement strips.

In this example, as shown in FIG. 1, the one or more conveying units 1, 2 are a first conveying unit 1 and a second conveying unit 2 downstream of the first conveying unit 1 in the conveyance direction A.

It will be understood that the scope of the invention also includes a tire manufacturing line having a single conveying unit or a tire manufacturing line having more than two conveying units. The one or more conveying units may be selected from a group comprising, but not limited to: a roller conveyor, a belt conveyor, a cooling drum and a festooner.

More in particular, the first conveying unit 1 comprises a shrink conveyor 10 with a plurality of conveyor rollers 11 which are configured to allow shrinking of the continuous strip 9 after it has been freshly extruded by the extruder 5. Each of the conveyor rollers 11 has a roller diameter, whereas at least one of the conveyor roller 11 has a smallest roller diameter E compared to the other conveyor rollers 11. The tire manufacturing line 100 is provided with a first drive 61 for driving rotation of at least one of the conveyor rollers 11 in a first drive direction R1 and a second drive direction R2 opposite to the first drive direction R1.

The second conveying unit 2 comprises a cooling drum 20 for cooling the continuous strip 9. The tire manufacturing line 100 is provided with a second drive 62 for driving rotation of the cooling drum 20 in both drive directions R1, R2.

In this exemplary embodiment the second conveying unit 2 further comprises one or more guide rollers 21 for guiding the continuous strip 9 in one or more windings around said cooling drum 20.

As shown in FIG. 1, the continuous strip 9 preferably has one or more slacking portions or passes through one or more loops or free loops 31, 32, 33. In this example a first loop 31 is provided between the extruder 5 and the first conveying unit 1, a second loop 32 is provided between the first conveying unit 1 and the second conveying unit 2, and a third loop 33 is provided between the second conveying unit 2 and the one or more downstream stations 4. Optionally, one or more buffer members (not shown) may be provided at the loops 31, 32, 33 to actively control the length of the continuous strip 9 in said loops 31, 32, 33. The buffer members may for example be dancer rollers.

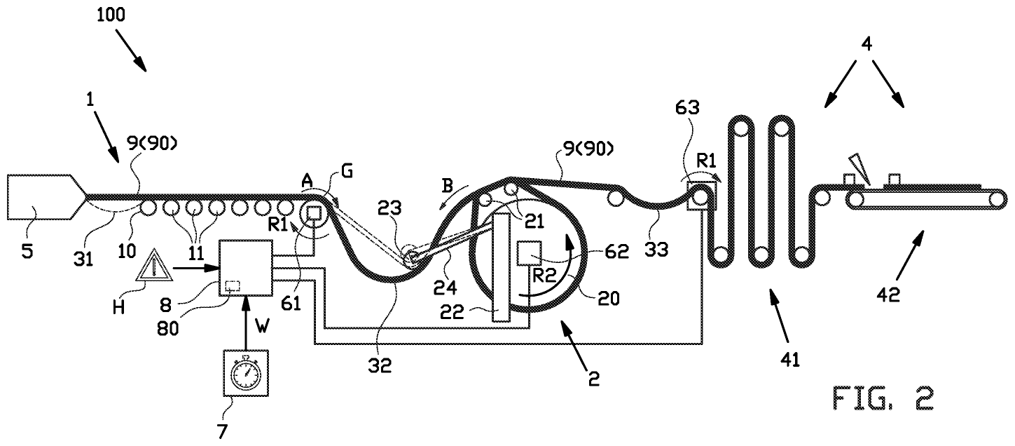

Optionally, the second conveying unit 2 may be provided with a tensioning device 22 for controlling tension in the continuous strip 9 in an area between the first conveying unit 1 and the second conveying unit 2, in particular at the aforementioned second loop 32. In this example, the tensioning device 22 comprises a tension roller 23 and a tension arm 24 for carrying the tension roller 23 relative to a hinge point. The tension roller 23 is allowed to passively rest on the continuous strip 9 in the second loop 32 directly upstream of the cooling drum 20 and the tension arm 24 passively adapts its orientation in accordance with the rest position of the tension roller 23 on the continuous strip 9 between a high tension state, as shown in FIG. 1 and a low tension state, as shown in FIG. 2. The reaction force of the continuous strip 9 supporting the weight of the tension roller 23, depending on the orientation of the tension arm 24 relative to the hinge point, can be resolved into components, including a tension component in the direction of the continuous strip 9 that is automatically varied depending on the orientation of the tension arm 24 about the hinge point.

It will be appreciated that different tensioning devices can be used to generate or control tension in the continuous strip 9, such as a conventional dancer roller or the like.

In this example, the tire manufacturing line 100 is further provided with a third drive 63 for driving the festooner 41 in both drive directions R1, R2.

As further shown in FIG. 1, the tire manufacturing line 100 comprises a timer 7 and a control unit 8. The control unit 8 is functionally, electronically and/or operationally connected to the drives 61, 62, 63 and the timer 7. The control unit 8 comprises a computer-readable medium, e.g. a memory, and processor (generally indicated with box 80). The computer-readable medium is configured to hold instructions that, when executed by the processor, cause the tire manufacturing line 100 to perform steps of a method for manufacturing the continuous strip 9, which will be described in more detail hereafter. In other words, the steps of the method are preconfigured, pre-programmed and/or can be executed automatically.

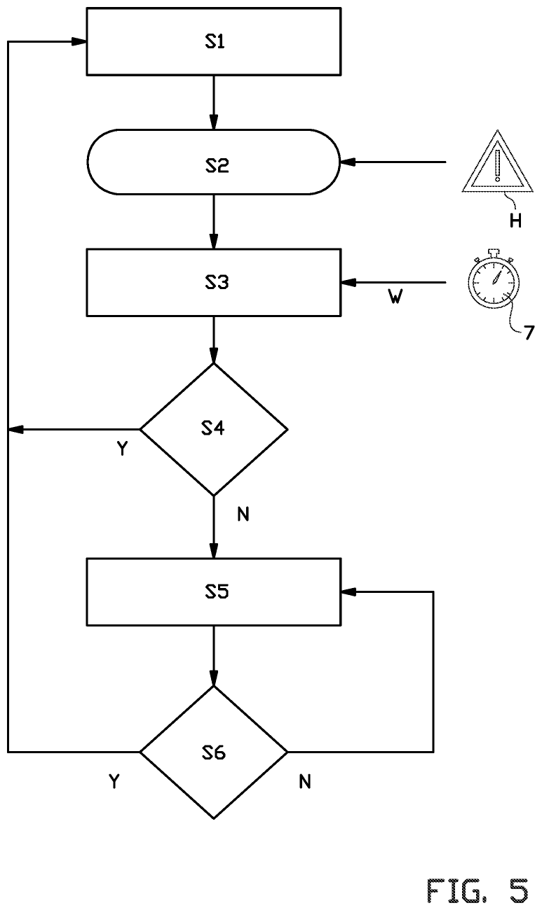

FIGS. 1-3 show the tire manufacturing line 100 during the steps of the method for manufacturing the continuous strip 9 in the tire manufacturing line 100. FIG. 5 is a flow chart showing the logic behind the steps of the method.

FIG. 1 shows the situation in which the tire manufacturing line 100 is operated or operating in a tire manufacturing mode (step S1 in FIG. 5). The control unit 8 controls the drives 61, 62, 63 to drive the first conveying unit 1, the second conveying unit 2 and the festooner 41 in the first drive direction R1, corresponding to or resulting in conveyance of the continuous strip 9 in the conveyance direction A from the extruder 5 towards the one or more downstream stations 4. In other words, when the tire manufacturing line 100 is operating normally, i.e. without malfunction or interruption, the continuous strip 9 is moved in a forward or downstream direction only.

FIG. 2 shows the situation in which the tire manufacturing line 100 is being switched over (Step S2 in FIG. 5) from the tire manufacturing mode (Step S1 in FIG. 5) to an interruption mode (Step S5 in FIG. 5) in response to an interruption signal H, schematically represented in FIG. 2 by an exclamation mark. The interruption signal H may be triggered by an automatically detected malfunction or error in the tire manufacturing line 100, or alternatively by a user input at a human machine interface (not shown). When the interruption signal H is received, the control unit 8 controls the drives 61, 62, 63 to slow down and/or stop conveyance of the continuous strip 9 in the conveyance direction A along the conveyance path G as soon as possible, thereby preventing damage to the continuous strip 9 and/or the tire manufacturing line 100.

Optionally, the control unit 8 is configured to control the drives 61, 62, 63 to reduce tension in the continuous strip 9 as much as possible prior to or shortly after stopping the conveyance of the continuous strip 9. The control unit 8 may for example control the first drive 61 and the second drive 62 to rotate in the first drive direction R1 and the second drive direction R2, respectively, such that an additional or excess length of the continuous strip 9 is fed into the second loop 32. In other words, slack is introduced in the continuous strip 9 at the tensioning device 22. As a result, the tension arm 24 of the tensioning device 22 will be lowered to a lower position or its lowest position, corresponding to the low tension state, thereby reducing the tension generated in the continuous strip 9 by the weight of the tension roller 22.

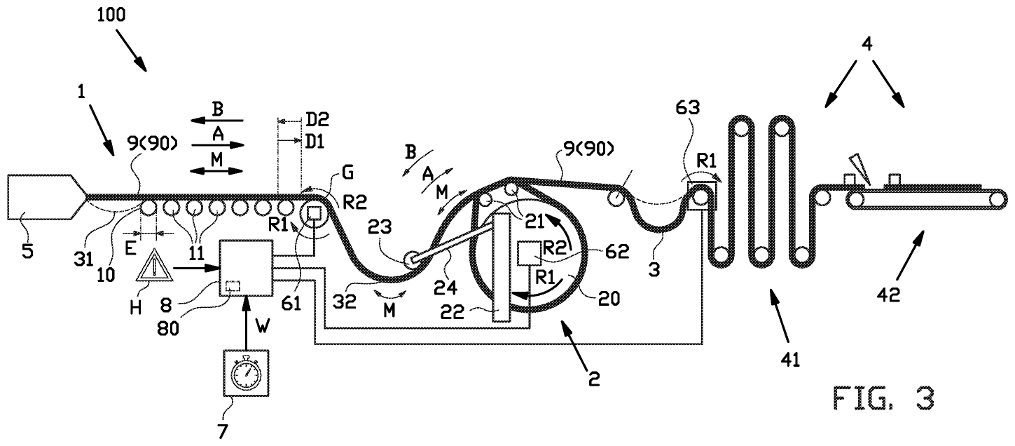

FIG. 3 shows the situation in which the tire manufacturing line 100 is operated in the interruption mode (Step S5 of FIG. 5). In the interruption mode, the control unit 8 is configured to automatically control at least one conveying unit 1, 2 to repeatedly move or rock the continuous strip 9 back-and-forth in the conveyance direction A and a retraction direction B opposite to the conveyance direction A along the conveyance path G, hereafter referred to as the ‘back-and-forth movement’ M, or alternatively as the ‘rocking movement’. The continuous strip 9 is moved over a first distance D1 in the conveyance direction A and over a second distance D2, opposite to the first distance D1, in the retraction direction B.

Note that the ‘back-and-forth movement’ M does not necessarily start with a ‘back’ movement. The interruption mode may also be initiated with a ‘forward’ movement. An initial ‘back’ movement is however preferred, because it will reduce tension in the continuous strip 9 rather than increasing said tension.

In this example, both the first conveying unit 1 and the second conveying unit 2 are synchronously or substantially synchronously controlled to move M the continuous strip 9 back-and-forth. In other words, both the first conveying unit 1 and the second conveying unit 2 are driven in the first drive direction R1 at the same time to convey the continuous strip 9 in the conveyance direction A and both are driven in the second drive direction R2 at the same time to convey the continuous strip 9 in the retraction direction B. Effectively, when one of the conveying units 1, 2 is pushing the length of continuous strip 9 between the conveying units 1, 2, the other conveying unit 1, 2 is pulling, and vice versa.

Alternatively, the first conveying unit 1 and the second conveying unit 2 are alternately controlled to move or pull M the continuous strip 9 in the retraction direction B and the conveyance direction A, respectively. Effectively, when one of the conveying units 1, 2 is pulling, the other is freely rotating and/or passively following the continuous strip 9.

In yet another alternative embodiment, the first conveying unit 1 and the second conveying unit 2 may be controlled independently, i.e. with the back-and-forth movement of the continuous strip 9 at one of the conveying units 1, 2 being unrestricted by the back-and-forth movement at the other conveying unit 1, 2. Any length variations may be absorbed in a free loop between the conveying units 1, 2. In the aforementioned embodiments, the control unit 8 controls the drives 61, 62 of the conveying units 1, 2 to move the continuous strip 9 in the back-and-forth movement M. Alternatively, the control unit 8 may set in motion another mechanical device at one or both of the conveying units 1, 2, for example a pendulum, to interact with the continuous strip 9 and generate the back-and-forth movement M.

Preferably, the continuous strip 9, after each repetition of the back-and-forth movement M returns to the same or substantially the same position along the conveyance path G. In other words, the net movement of the continuous strip 9 is zero or substantially zero. In any case, the net movement is substantially or considerably smaller than the movement of the continuous strip 9 in the tire manufacturing mode.

Alternatively, the continuous strip 9 may be returned to a different position along the conveyance path G after each repetition, in other words progressively moving the continuous strip 9 in the conveyance direction A or the retraction direction B, to ensure that different sections of the continuous strip 9 are supported on the respective conveying units 1, 2 over time.

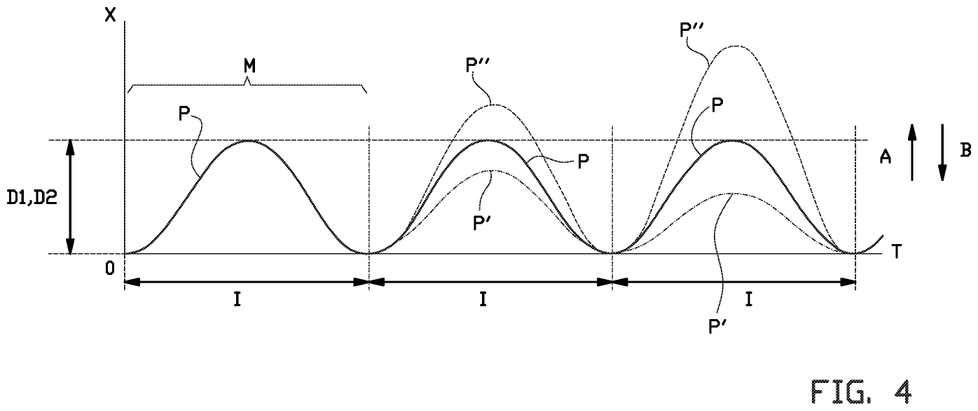

The graph of FIG. 4 shows a first drive profile P, a second drive profile P′ and a third drive profile P″ for controlling the position (on the “X” axis) of the continuous strip 9 over time (on the “T” axis).

The upward slopes of the drive profiles P, P′, P″ are representative of the movement of the continuous strip 9 in the conveyance direction A, whereas the downward slopes of the drive profiles P, P′, P″ are representative of the movement of the continuous strip 9 in the retraction direction B. Note that the second distance D2 is equal to the first distance D1 for each repetition of the back-and-forth movement M of the continuous strip 9, resulting in the aforementioned net zero movement.

The first distance D1 or the second distance D2 is at least three centimeters, preferably at least five centimeters and most preferably at least eight centimeters. In this example, the distances D1, D2 are at least equal to the smallest roller diameter E of the rollers 11, 21 on which the continuous strip 9 is supported at the first conveying unit 1 and/or the second conveying unit 2.

In this example, the back-and-forth movement M of the continuous strip 9 in step d) is sinusoidal. Alternatively, the back-and-forth movement M may have a truncated sinusoidal shape (i.e. having a brief delay between the movement of the continuous strip 9 in the conveyance direction A and the retraction direction B) or a non-sinusoidal shape, such as a trapezoidal profile or a higher order curve, such as a fourth order curve.

The first drive profile P is representative of a constant back-and-forth motion M. In other words, the first distance D1 and the second distance D2 are constant for all repetitions of the back-and-forth motion M. The second drive profile P′ is representative of a back-and-forth motion with a decreasing amplitude over time. In other words, the distance D1, D2 over which the continuous strip 9 is moved is decreased between repetitions of the back-and-forth movement M. The third drive profile P″ is representative of a back-and-forth motion with an increasing amplitude over time. In other words, the distance D1, D2 over which the continuous strip 9 is moved is increased between repetitions of the back-and-forth movement M.

Note that for all drive profiles P, P′, P″, the back-and-forth movement M is a periodic motion, meaning that the motion is repeated at a regular or constant interval I. It will however be appreciated that the duration of the repetitions may be varied in a non-periodic manner, for example with an incremental increase or decrease of the interval I.

In this example, as shown in FIG. 5, a time delay W is introduced (Step S3) between the tire manufacturing mode (Step S1) and the interruption mode (Step S5) based on an input from the timer 7. The timer 7 is started at the moment of switch-over (Step S2) or shortly thereafter, for example when the continuous strip 9 has come to a stop in the conveyance direction A. Preferably, the time delay W is at least ten seconds, more preferably at least thirty seconds and most preferably at least one minute. In Step S4, a check is made whether the tire manufacturing line 100 is switched back to the tire manufacturing mode before expiry of the time delay W. If yes (see arrow “Y”), the interruption mode (Step S5) is cancelled and the flowchart returns to the tire manufacturing mode (Step S1). If no (see arrow “N”), the aforementioned interruption mode (Step S5) is initiated.

In Step S6, the tire manufacturing line 100 is switched back (see arrow “Y”) from the interruption mode to the tire manufacturing mode when a switch back signal has been received from a human machine interface or in response to an automatic detection that the malfunction or error triggering the interruption signal H has been resolved. As long as the switch back signal has not been received, the interruption mode (Step S5) is continued, as reflected by the “N” arrow.

In the example as shown in FIG. 3, the downstream stations 4 directly downstream of third loop 33 are controlled to hold the continuous strip 9 stationary in the conveying direction A along the conveyance path G in the interruption mode. It will however be appreciated that, if needed, at least one of said downstream stations 4, for example the festooner 41, may be controlled as if it were a conveying unit, in the same manner as the aforementioned conveying units 1, 2, to move the continuous strip 9 back-and-forth in the interruption mode, with the same technical effects.

In particular, the festooner 41 may be used to absorb and pay out a varying length of the continuous strip 9 at a side upstream of said festooner 41 to minimize or eliminate the forming of loops in the strip 9 and/or to eliminate the need for loops directly upstream of said festooner 41.

In yet a further alternative embodiment, the festooner 41 is considered as one of the one or more conveying units 1, 2, in which case the varying length of the strip 9 is absorbed in a loop downstream of said festooner 41, for example in a dancer roller (not shown) between the festooner 41 and the cutter 42. This has the additional advantage that the continuous strip 9 can be repeatedly moved back-and-forth throughout the festooner 41, thereby reducing the risk of the continuous strip 9 sticking to any part of the festooner 41.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 first conveying unit
10 shrink conveyor
11 conveyor roller
2 second conveying unit
20 cooling drum
21 guide roller
22 tensioning device
23 tension roller
24 tension arm
31 loop
32 loop
33 loop
4 downstream station
41 festooner
42 cutter
5 extruder
61 first drive
62 second drive
63 third drive
7 timer
8 control unit
80 computer readable medium and processor
9 continuous strip
90 apex
100 tire manufacturing line
A conveyance direction
B retraction direction
D1 first distance
D2 second distance
E smallest roller diameter
G conveyance path
H interruption signal
I interval
M back-and-forth movement
P drive profile
P′ alternative drive profile
P″ further alternative drive profile
R1 first drive direction
R2 second drive direction
S1 step “operating the tire manufacturing line in tire manufacturing mode”
S2 step “switching over the tire manufacturing line from tire manufacturing mode to interruption mode”
S3 step “timer input”
S4 step “tire manufacturing line switched back before expiry of time delay?”
S5 step “interruption mode: repeatedly move the continuous strip back-and-forth”
S6 step “switch back signal received?”
T time
W time delay
X position

1. A method for manufacturing a continuous strip in a tire manufacturing line, wherein the tire manufacturing line comprises at least one conveying unit for conveying the continuous strip along a conveyance path through the tire manufacturing line, wherein the method comprises the steps of:
a) operating the tire manufacturing line in a tire manufacturing mode;
b) controlling the at least one conveying unit to convey the continuous strip in a conveyance direction along the conveyance path in the tire manufacturing;
c) switching over at least a part of the tire manufacturing line, including the at least one conveying unit, from the tire manufacturing mode to an interruption mode; and
d) controlling the at least one conveying unit in the interruption mode to repeatedly move the continuous strip back-and-forth in the conveyance direction and a retraction direction opposite to the conveyance direction along the conveyance path.

2. The method according to claim 1, wherein the at least one conveying unit, in step c), is controlled to stop moving the continuous strip along the conveyance path.

3. The method according to claim 2, wherein step d) is delayed from step c) with a time delay.

4. The method according to claim 3, wherein the time delay is at least ten seconds.

5. The method according to claim 1, wherein the continuous strip, after each repetition of the back-and-forth movement in step d) returns to the same position along the conveyance path.

6. The method according to claim 1, wherein the continuous strip, after each repetition of the back-and-forth movement in step d) returns to a different position along the conveyance path.

7. The method according to claim 1, wherein the continuous strip is moved back-and-forth in step d) over a first distance in the conveyance direction and a second distance in the retraction direction.

8. The method according to claim 7, wherein the second distance is equal to the first distance for each repetition of the back-and-forth movement of the continuous strip in step d).

9. The method according to claim 7, wherein the first distance remains constant for all repetitions of the back-and-forth movement of the continuous strip in step d).

10. The method according to claim 7, wherein the first distance is variable between repetitions of the back-and-forth movement of the continuous strip in step d).

11. The method according to claim 10, wherein the first distance is incrementally varied between repetitions of the back-and-forth movement of the continuous strip in step d).

12. The method according to claim 7, wherein the first distance or the second distance is at least five centimeters.

13. The method according to claim 1, wherein the back-and-forth movement of the continuous strip in step d) is a periodic motion.

14. The method according to claim 1, wherein the back-and-forth movement of the continuous strip in step d) is a non-periodic motion.

15. The method according to claim 1, wherein the continuous strip, in the tire manufacturing mode, is moved in the conveyance direction at a production speed, wherein the continuous strip, in the interruption mode, is moved back-and-forth in step d) at an interruption speed that is less than eighty percent of the production speed.

16. The method according to claim 1, wherein the back-and-forth movement of the continuous strip in step d) is controlled automatically.

17. The method according to claim 1, wherein the back-and-forth movement of the continuous strip in step d) is pre-programmed.

18. The method according to claim 1, wherein the tire manufacturing line is switched over from the tire manufacturing mode to the interruption mode in response to an interruption signal.

19. The method according to claim 18, wherein the interruption signal is triggered by one of an automatically detected error in the tire manufacturing line or a user input at a human machine interface.

20. The method according to claim 1, wherein the at least one conveying unit comprises a first conveying unit and a second conveying unit located downstream of the first conveying unit along the conveyance path.

21. The method according to claim 20, wherein the first conveying unit and the second conveying unit are synchronously controlled to move the continuous strip back-and-forth in step d).

22. The method according to claim 20, wherein the first conveying unit and the second conveying unit are alternately controlled to move the continuous strip in the retraction direction and the conveyance direction, respectively, in step d).

23. The method according to claim 20, wherein the tire manufacturing line further comprises a tensioning device for tensioning the continuous strip between the first conveying unit and the second conveying unit, wherein the method further comprises the step of:
e) controlling the first conveying unit and the second conveying unit prior to or during step d) to generate excess length in the continuous strip at the tensioning device.

24. The method according to claim 1, wherein the tire manufacturing line further comprises a tensioning device that is movable between a low tension state and a high tension state for variably tensioning the continuous strip, wherein the method further comprises the step of:
e) controlling the tensioning device to move from the high tension state towards or into the low tension state.

25. The method according to claim 1, wherein the at least one conveying unit comprises conveyor rollers.

26. The method according to claim 1, wherein the tire manufacturing line comprises an extruder for extruding the continuous strip, wherein the at least one conveying unit comprises a shrink conveyor for receiving the continuous strip from said extruder.

27. The method according to claim 1, wherein the at least one conveying unit comprises a cooling drum.

28. The method according to claim 1, wherein the at least one conveying unit comprises a festooner.

29. The method according to claim 1, wherein the tire manufacturing line comprises at least one downstream station downstream of the at least one conveying unit, wherein the at least one downstream station is controlled to hold the continuous strip stationary in the conveying direction along the conveyance path in the interruption mode.

30. The method according to claim 29, wherein the at least one downstream station comprises a festooner.

31. The method according to claim 1, wherein the continuous strip is a cordless strip.

32. The method according to claim 1, wherein the continuous strip is a cord-reinforced strip.

33. A tire manufacturing line for manufacturing a continuous strip, wherein the tire manufacturing line comprises at least one conveying unit configured for conveying the continuous strip along a conveyance path through the tire manufacturing line and a control unit that is operationally connected to the at least one conveying unit, wherein the control unit is configured for executing the steps of the method according to claim 1.

34. A computer program product comprising a non-transitory computer-readable medium holding instructions that, when executed by a processor, cause a tire manufacturing line for manufacturing a continuous strip, which tire manufacturing line comprises at least one conveying unit configured for conveying the continuous strip along a conveyance path through the tire manufacturing line and a control unit that is operationally connected to the at least one conveying unit, to perform the steps of the method according to claim 1.
